(19) United States
(12) Patent Application Publication
(10) Pub. No.: US 2014/0275303 A1
(43) Pub. Date: Sep. 18, 2014

(54) RODENT RESISTANT POLYURETHANE FOAMS

(71) Applicant: CLAYTON CORPORATION, St. Louis, MO (US)

(72) Inventors: Nickolas R. Yeates, Affton, MO (US); Jay Yuan Zhang, Ballwin, MO (US); Timothy A. Niemeyer, Fenton, MO (US); Timothy L. Franklin, Fenton, MO (US)

(73) Assignee: CLAYTON CORPORATION, St. Louis, MO (US)

(21) Appl. No.: 13/843,602

(22) Filed: Mar. 15, 2013

(51) Int. Cl. C08J 9/00

(52) U.S. Cl. CPC C08J 9/0004
USPC 521/99

(57) ABSTRACT

One component polyurethane foam forming compositions are provided which contain a rodent repellent yet have shelf life stability of at least 6 months at 20° C. Two component polyurethane foam forming compositions are also provided.

### FIELD OF THE INVENTION

The present invention generally relates to compositions and methods for making rodent-resistant polyurethane foams. More particularly, the invention relates to one- and two-component polyurethane foams incorporating chemical irritants.

### BACKGROUND OF THE INVENTION

Polyurethane spray foams and their methods of manufacture are well known. Briefly, the polyurethane polymer is formed by an exothermic chemical reaction between a polyisocyanate and a polyol. This polymerization reaction is typically catalyzed by tertiary amines and organometallic compounds of tin, zinc, bismuth, etc. Transforming the polymer into a foam requires formation of a gas at the same time as urethane polymerization is occurring. If water is present, gaseous carbon dioxide will be produced by the chemical reaction between isocyanates and water. Alternatively, low boiling liquids can be added as physical blowing agents that are chemically unreactive, but are vaporized by the heat generated by the polymerization reaction. Surfactants in the foam forming composition stabilize the growing cell bubbles and regulate their size. Gas bubbles in the polymer expand upon reduction of pressure in the system, and remain trapped within the bubbles of the foam. The initial liquid foam cures to a material ranging from a sponge to a solid foam.

Typically, polyurethane spray foams are formed from two-component systems, commonly referred to as an “A” side and a “B” side, that react when they are mixed. Component “A” contains a diisocyanate or a polyisocyanate with or without further additives, and component “B” generally contains a polyol, having two or more hydroxyl groups, primary or secondary polyamines, and/or water. The “B” side component may include surfactants, catalysts, blowing agents, and other additives. The two components are stored in separate containers, or stored in separate compartments within the same container. Typically, the components of the “A” side and the components of the “B” side are delivered though separate lines into a spray device, such as an impingement mixing or static mixing type spray gun, in a 1:1 ratio. The two materials are kept separate throughout this entire system until they come together in the mixing head of the dispensing unit.

Two-component systems of this type require dispensing equipment that may be expensive and/or require a significant amount of space. Thus, these methods for manufacturing polyurethane spray foam may not be cost effective if only a small quantity of prepacked in one container react to form pre-polymer. When dispensed, the liquid contents come out as frothed foam which undergoes further reaction with atmospheric moisture to crosslink and cure the polymer. However, there are challenges in formulating a one-component foam forming composition that is storage stable, provides enough blowing agent to get good expansion, and cures under defined circumstances.

A one-component foam is needed. Further, the release of volatile materials present in the foam formulations requires applications where good ventilation is possible.

One-component polyurethane foam formulations that overcome these limitations of two-component systems have gained popularity as adhesives, sealants, and insulating materials. The foam forming composition is sold in a pressurized container and dispensed using straw/trigger assemblies and gunlike attachments with trigger mechanisms. A one-component polyurethane foam forming composition significantly differs from a two-component composition in that both “A” and “B” components polyurethane spray foam sold by Dow Chemical Company under the name Great Stuff Pestblock® is advertised to block ants, roaches, spider, bees, mice, and rats, and comprises the bittering agent, denatonium benzoate. The utility of this foam as a rodent repellent and the shelf-life stability of the foam forming composition is unknown.

### SUMMARY OF THE INVENTION

Among the aspects of the invention is a one-component polyurethane foam forming composition comprising (a) about 35 to about 55% by weight of a polyisocyanate; (b) about 10 to about 30% by weight of a polyol; (c) about 1.0 to about 10.0% by weight of a rodent repellent; and (d) about 10 to about 30% by weight of a blowing agent. The weight ratio of polyisocyanate and polyol are such that the NCO/OH equivalent ratio is within the range of about 3:1 to about 10:1; and the composition has a shelf-life stability of at least 12 months at 25° C.

Another aspect is a method of making a one-component polyurethane foam forming composition of any one of claims 1 to 23 comprising the steps of: sequentially adding polyol, the flame retardant, the surfactant, and the catalyst to a mixing vessel to form a premix; adding a liquified form of the rodent repellent to the premix to form a polyol blend; charging a container with the polyol blend; charging the container with the polyisocyanate after charging it with the polyol blend; and charging the container with the blowing agent after charging it with the polyisocyanate.

Yet another aspect of the invention is a two-component polyurethane foam forming composition which comprises: an “A” side and a “B” side. The “A”-side comprises about 70 to about 95% by weight of a polyisocyanate; about 4 to about 15% by weight of a blowing agent; and about 1 to about 10% by weight of dichlorobenzene. The “B”-side comprises about 20 to about 70% by weight of a polyol; and about 2 to about 30% by weight of a blowing agent wherein the weight ratio of polyisocyanate and polyol are such that the NCO/OH equivalent ratio ranges from about 0.8:1 to about 1.4:1.

A further aspect is a two-component polyurethane foam forming composition which comprises an “A” side and a “B” side. The “A”-side comprises about 80 to about 95% by weight of a polyisocyanate; and about 5 to about 15% by weight of a blowing agent. The “B”-side comprises about 20 to about 70% by weight of a polyol; about 2 to about 30% by weight of a blowing agent; and about 1 to about 11% by weight of dichlorobenzene wherein the weight ratio of polyisocyanate and polyol are such that the NCO/OH equivalent ratio ranges from about 0.8:1 to about 1.4:1.

An additional aspect is a two-component polyurethane foam forming composition which comprises an “A” side and a “B” side. The “A”-side comprises about 75 to about 95% by weight of a polyisocyanate; about 4 to about 15% by weight of a blowing agent; and about 1 to about 10% by weight of dichlorobenzene. The “B”-side comprises about 20 to about 70% by weight of a polyol; about 2 to about 30% by weight of a blowing agent; and about 1 to about 11% by weight of dichlorobenzene wherein the weight ratio of polyisocyanate and polyol are such that the NCO/OH equivalent ratio ranges from about 0.8:1 to about 1.4:1.

The invention is also directed to one-component polyurethane foams containing at least one rodent repellent that is an eye and mucous membrane irritant. Compounds useful as rodent repellents in the present invention include camphor, naphthalene, adamantane, 1,2-dichlorobenzene, 1,3-dichorobenzene, and 1,4-dichlorobenzene. The invention also relates to methods of making the polyurethane foam forming compositions and to their practical use as effective rodent repellents.

### BRIEF DESCRIPTION OF THE DRAWINGS

FIG. 1 shows a graph of the dichorobenzene concentration versus the days of foam life.

### DESCRIPTION OF THE INVENTION

According to the present invention, it has now been discovered that a polyurethane foam containing certain chemical irritants of the nose and mucous membranes can be employed usefully as a rodent resistant polyurethane foam, having all the desirable physical characteristics normally associated with such foams. The foam remains resistant to rodents for at least six months when applied to a surface. The polyurethane foam of the present invention can be prepared as either a one-component or a two-component system, thus making it suitable for both household and commercial applications. The foam forming compositions are particularly advantageous because they can be packaged and stored for at least twelve months at 25° C. in a one-component system such as an aerosol can or pressurized cylinder, and conveniently dispensed without specialized equipment. The method and means of accomplishing this will become apparent from the detailed description of the invention, which follows below.

Without being bound by or to any particular theory, the rodent repellent encapsulated within the polyurethane foam is thought to repel rodents by one or more of the following factors. The chemicals shown to be efficacious as rodent repellents in this invention have an unpleasant, penetrating odor that may generally contribute to their utility as aversive agents. Sniffing is an important part of the feeding behavior of rodents; rats can discriminate and begin responding to novel odors in as little as 140 milliseconds (Wesson, D. W., Carey, R. M., Verhagen, J. V., Wachowiak, M., PLOS Biology, 2008, 6(4): 0717-0729, “Rapid Encoding and Perception of Novel Odors in the Rat”). Since the sense of smell exerts a profound impact on many animal behaviors, including feeding, the odor of the rodent repellent may be suppressing appetite through stimulation of the animal's olfactory-limbic system.

The rodent repellents in this invention may also be acting as chemical irritants. The trigeminal nerve innervates the mucosa and skin of the face, nasal cavity, oral cavity, and eyes. Exposure to sensory irritants in air promotes a burning and painful sensation in the nasal passages, head, and cornea caused by stimulation of trigeminal nerve endings (Clinical Environment Health and Toxic Exposure, Lippincott Williams & Wilkins, 2001, Chapter 29, John B. Sullivan Jr., “Olfactory and Nasal Toxicology”). In the nasal cavity of rodents, trigeminal free nerve endings responsive to noxious stimuli terminate within a few micrometers of the tissue surface. (Finger, T. E., St. Jeor, V. L., Kinnamon, J. C., Silver, W. L., J Comp Neurol, 1990, 294(2): 293-305, “Ultrastructure of substance P- and CGRP-immunoreactive fibers in the nasal epithelium of rodents”).

### Polyisocyanates

Suitable organic polyisocyanates, defined as having two or more isocyanate functionalities, are conventional aliphatic, cycloaliphatic, and aromatic polyisocyanates. The polyisocyanates can be used individually or in the form of mixtures. Exemplary aliphatic and cycloaliphatic isocyanates include hexamethylene diisocyanate (HDI), isophorone diisocyanate (IPDI), cyclohexane diisocyanate (CHDI), and dicyclohexylmethane-4,4′-diisocyanate (H₁₂MDI), and isomers and oligomers thereof. Preferably, the polyisocyanate comprises an aromatic polyisocyanate, such as toluene diisocyanate (TDI), phenylene diisocyanate, naphthalene 1,5-diisocyanate (NDI), methylene diphenyl diisocyanate (MDI), polymeric methylene diphenyl diisocyanate (PMDI), triphenylmethane triisocyanate, or isomers or mixtures thereof; MDI based polyisocyanates and their derivatives are preferred.

For one-component foam forming compositions, a blend of MDI/PMDI comprising about 20 to about 70% by weight MDI, about 25 to about 65% by weight MDI, or about 30 to about 60% by weight MDI is preferred. For two-component foam forming compositions, a blend of MDI/PMDI comprising from about 20 to about 100% by weight MDI, about 40 to about 95% by weight MDI, or about 50 to about 95% by weight MDI is preferred. Examples of commercially available aromatic polyisocyanates suitable for use in the present invention include, but are not limited to, Rubinate M from Huntsman Corporation (Salt Lake City, Utah), Lupranate M20 from BASF (Florham Park, N.J.), Mondur MR from Bayer Material Science (Leverkusen, Germany), and Papi 27 from Dow Chemical (Midland, Mich.). Any conventional polyisocyanate used in polyurethane foams can be selected for the foam forming compositions of the invention.

The weight ratio of polyisocyanate and polyol are such that the NCO/OH equivalent ratio ranges from about 3:1 to about 10:1 for the one-component foam forming composition, and from about 0.8:1 to about 1.4:1 for the two-component foam forming composition. Preferably, the polyisocyanate is present in the one-component foam forming composition of the present invention in an amount from 30 to 55 wt. %. For two-component foam forming compositions, the polyisocyanate is preferably 70 to 95 wt. % of the A-side.

### Polyols

A wide variety of polyols may be used in the present invention, including polyether polyols, polyester polyols, polybutadiene polyols, polycaprolactone polyols, polycarbonate polyols, hydroxyl-terminated polyolefin polyols, grafted/polymer polyols, and polyols derived from natural sources. The polyol can be used individually or in the form of mixtures. The polyols generally have a molecular weight range of from 200 to 6000, more preferably from 350 to 4800, and most preferably from 400 to 3000. As used herein, “polyol” refers to a molecule that has an average of greater than 1.0 hydroxyl group per molecule. The polyol may have thiol and/or amine functionalities in addition to hydroxyl groups. Any conventional polyol used in polyurethane foams can be selected for the foam forming compositions of the invention.

The polyols can have a hydroxyl number (OH number) ranging from 28 to 800 mg/KOH g. Hydroxyl number indicates the number of reactive hydroxyl groups available and is expressed as the number of milligrams of potassium hydroxide equivalent to the hydroxyl content of one gram of the sample.

The polyols can have a number average hydroxyl functionality (Fn) of about 6.2 or less. Number average hydroxyl functionality refers to the average number of pendant hydroxyl groups (primary, secondary, or tertiary) that are present on a molecule of the polyol.

Preferably, the polyol comprises a polyether polyol or a polyester polyol. The use of specialty polyols such as polycarbonate polyols, polycaprolactone polyols, polybutadiene polyols, hydroxyl-terminated polyolefin polyols, and filled polyols are also within the scope of this invention.

In additional to polyols derived from petrochemicals, the polyols for use in the present invention may be derived from a natural source, such as fish oil, lard, tallow, and plant oil (see for example, US2010/048754 and U.S. Pat. No. 7,672,295). Plant based polyols may be made from any plant oil or oil blends containing sites of unsaturation, including, but not limited to, soybean oil, castor oil, palm oil, canola oil, linseed oil, rapeseed oil, sunflower oil, safflower oil, olive oil, peanut oil, sesame seed oil, cotton seed oil, walnut oil, and tung oil.

Examples of commercially available polyols suitable for use in the present invention include, but are not limited to, Voranol 470X from Dow Chemical (Midland, Mich.), Arcol F 3022 from Bayer Material Science (Leverkusen, Germany), and Pluracol GP730 from BASF (Florham Park, N.J.). Preferably, the polyol is present in the one-component foam forming composition of the present invention in an amount from 10 to 30 wt. %. For two-component foam forming compositions, the polyol is preferably 20 to 70 wt. % of the B-side.

### Catalysts

The foam forming compositions of the invention preferably include a catalyst, which is used to accelerate the reaction of the polyisocyanate and polyol, and in the case of one component foams, accelerate the post moisture cure of the formulation to a finished foam once the product has been dispensed. Suitable catalysts include primary, secondary, and tertiary amines, with tertiary amine catalysts being particularly preferred. Tertiary amine catalysts include, but are not limited to, dimethylethanol amine (DMEA), tetraethylenediamine (TEDA), tetramethyliminobispropyl amine (Polycat 15), N,N-dimethylcyclohexylamine (DMCHA), and 2,2′-dimorpholinodiethylether (DMDEE).

Other suitable catalysts include alkali metal carboxylates (e.g. potassium acetate, potassium octoate, sodium acetate, sodium octoate), heavy metal-based catalysts such as those of mercury or lead (e.g. lead octoate, lead benzoate, lead naphthanate), organometallic catalysts (e.g. nickel acetoacetonate, iron acetoacetonate, zinc octoate, stannous octoate, dilauryltin dichloride, dibutyltin dilaurate, dibutyltin diacetate, dimethyltin dineodecanoate, cobalt naphthenate, nickel naphthenate) and Lewis acid catalysts (e.g. ferric chloride, antimony trichloride, bismuth nitrate).

These catalysts may be used alone or in the form of a mixture of any two or more thereof. Generally, only a small amount of catalyst is used. Preferably, the catalyst is present in the one-component foam forming composition of the present invention in an amount from 0.1 to 3 wt. %. For two-component foam forming compositions, the catalyst is preferably 0.1 to 6 wt. % of the B-side.

### Blowing Agents

In addition to the components set forth above, the foam forming compositions of the present invention contain at least one blowing agent. The blowing agent can be a fully or partially halogenated hydrocarbon, including a fluorocarbon, a chlorocarbon, a hydrofluorocarbon, or a hydrochlorofluorocarbon. Examples of suitable halogenated blowing agents include, but are not limited to, difluoromethane (HFC-32), pentafluoroethane (HFC-125), 1,1,2,2-tetrafluoroethane (HFC-134), 1,1,1,2-tetrafluoroethane (HFC-134a), 1,2-difluorethane (HFC-142), 1,1,1,3,3-pentafluoropropane (HFC-245fa), 1,1,1-trichloroethane, dichloropropane, chlorodifluoromethane (HCFC-22), 1,1-dichloro-2,2,2-trifluoroethane (HCFC-123), 1-chloro-1,1-difluoroethane (HCFC-142b), dichlorodifluoromethane (CFC-12), trichlorotrifluoroethane (CFC-113), dichlorotetrafluoroethane (CFC-114), or a mixture thereof.

Other blowing agents suitable for the present invention include inert gases (e.g. nitrogen, carbon dioxide, nitrous oxide), low molecular weight hydrocarbons (e.g. propane, butane, isobutane, pentane, isopentane, cyclopentane), ethers (e.g. furan, dimethyl ether, diethyl ether), ketones (e.g. acetone, methyl ethyl ketone), alkyl carboxylates (methyl formate, ethyl acetate), hydrofluoroolefins (e.g. cis-1,1,1,4,4,4-hexafluoro-2-butene), hydrochlorofluoroolefins (e.g. trans-1-chloro-3,3,3-trifluoropropene) or a mixture thereof.

One or more blowing agents may be used in the foam forming compositions of the present invention; the blowing agent may function as propellant too. Desirably, the blowing agent is non-reactive with other components, is environmentally friendly, has little ozone depletion potential, and little to no global warming potential. Particularly preferred blowing agents include, but are not limited to, Ennovate 3000 and Solstice LBA from Honeywell (Morristown, N.J.), Forane 134a from Arkema Inc. (King of Prussia, Pa.), Formacel Z-4 from DuPont (Wilmington, Del.), dimethylether, hydrocarbons such as propane, butane, and isomers thereof, and blends containing two or more of these blowing agents. Preferably, the blowing agent is present in the one-component foam forming composition of the present invention in an amount from 10 to 30 wt. %. For two-component foam forming compositions, the blowing agent is preferably 4 to 15 wt. % of the A-side and 2 to 30 wt. % of the B-side.

### Surfactants

The foam forming compositions of this invention can contain a surfactant, whether the compositions are expanded with carbon dioxide from the reaction of any water present with isocyanate or with an inert blowing agent. Surfactants are employed to assist with the homogenization of the starting materials, to regulate the cell structure of the foams, and to stabilize the foam against collapse. Nonionic surfactants are preferred, particularly silicone/ethylene oxide/propylene oxide copolymers.

Examples of suitable siloxane surfactants are polydimethylsiloxane and polyether-polysiloxane copolymers. Siloxane surfactants provide rapid emulsification of the polyurethane reactants, which is particularly important in very fast reacting formulations. Siloxane surfactants decrease the surface tension of liquid reaction mixtures, thus promoting thinner cell walls. They also promote generation of a large number of small bubbles and control bubble size distribution within a narrow range.

Examples of commercially available siloxane surfactants include Dabco® DC series 193 from Air Products and Chemicals, Inc. (Allentown, Pa.), Tegostab® B series B8407, B8404 from Evonik Goldschmidt Chemical Corporation (Hopewell, Va.) and Niax® L-series surfactants L5340, L5420, L6900 from OSI Specialties, now a division of Momentive Performance Materials (Albany, N.Y.).

Other examples of suitable surfactants include alkoxylate, ethoxylate, poly- and monoglucoside, as well as anionic materials. Examples of commercially available surfactants in this category include Triton X-15, Triton X-100, Tergitol NP-4, Tergitol NP-9, Tergitol NP-10 from Dow Chemical (Midland, Mich.), and Surfonic N-95 from Huntsman Corporation (Salt Lake City, Utah). Preferably, the surfactant is present in the one-component foam forming composition of the present invention in an amount from 0.1 to 3 wt. %. For two-component foam forming compositions, the surfactant is preferably 0.1 to 3 wt. % of the A-side and 0.1 to 15 wt. % of the B-side.

### Rodent Repellents

Commercially available one-component polyurethane spray foams incorporate bittering agents, such as denatonium salts, as aversive agents. Denatonium, usually available as denatonium benzoate (under trade names such as Bitrex® or Aversion®), is the most bitter chemical compound known.

A second category of aversive agents includes pungent agents, which produce a sharp biting taste and burning sensation when they comes in contact with mucous membranes and skin (U.S. Consumer Products Safety Commission, Study of Aversive Agents, Nov. 18, 1992). Common pungent agents include capsaicin (red chile peppers), piperine (black pepper), allyl isothiocyanate (oil of mustard), and resinferatoxin (a plant extract from Euphorbia resinifera).

Capsaicin is the active ingredient in riot control and personal defense pepper sprays, and has also been used to deter animal pests. Capsaicin binds to vanilloid receptor TRPV1 in sensory neurons, an ion channel receptor which can also be stimulated with heat and physical abrasion. Pungency is due to the 3-methoxy-4-hydroxybenzyl residue in the capsaicin molecule, and the hydroxyl group at the C-4 position of the aromatic ring is critical for the perception of pungency and pain. Our attempts to use capsaicin as a rodent repellent in polyurethane foam were unsuccessful. Both one- and two-component polyurethane foams were prepared using hot pepper oil at a concentration of 2 wt. %. Unfortunately, the hot pepper oil was reactive with MDI, and the cured foam from these trials did not have a “hot” taste or smell.

Chemical irritants of the eye and mucous membranes that are non-reactive to the components of the polyurethane foam forming composition were found to be effective rodent repellents in both one- and two-component polyurethane foams. Without being bound by or to any particular theory, it is thought that the chemical irritant becomes encapsulated into the cells and polymer matrix of the polyurethane foam, and is released when the foam is chewed by a rodent. Burning pain to the eyes, nose, and throat of the rodent deters further ingestion. Prolonged inhalation of such chemicals could also result in loss of appetite, nausea, and vomiting.

Ortho-dichlorobenzene (ODCB) or para-dichlorobenzene (PDCB) can be incorporated into stable foam forming compositions and produce polyurethane foam of good quality. The concentration of the rodent repellent used is preferably in the range of about 1 to about 11 wt. %.

In addition to ODCB and PDCB, other exemplary rodent repellents include m-dichlorobenzene, adamantane, camphor, and naphthalene. Other suitable rodent repellents are any chemicals that are severe eye and mucous membrane irritants, non-reactive with polyisocyanates or polyols, and either a liquid or a sublimable solid.

For one-component foam forming compositions, it is preferred to add a liquified form of the rodent repellent to a premix comprising the polyol, flame retardant, catalyst, and surfactant. After charging the dispensing vessel with the polyol blend, it is then charged with the polyisocyanate and blowing agent, respectively. Preferably, the rodent repellent is about 3 to 10 wt. % of the composition.

Alternatively, the rodent repellent can be added as a solid to the polyol or to the premix. When the rodent repellent is added in this manner, the resulting mixture must be heated with agitation to dissolve the solid. If the rodent repellent is added to the polyol, additional components needed to form the polyol blend are added after dissolving the solid.

For the preparation of two-component polyurethane foam forming compositions, the total amount of rodent repellent is about 1 to about 11 wt. % of the composition. The rodent repellent can be incorporated into the A-side, the B-side, or divided into both A- and B-sides. It is preferable to preheat the rodent repellent to liquefy it prior to addition to ensure that the repellent is thoroughly dissolved.

### Flame Retardants and Other Additives

Conventional flame retardants, such as brominated aromatic polyols, can be incorporated into the foam forming compositions of the invention. Suitable phosphorous based flame retardants include diammonium phosphate, halogenated phosphates, organophosphates, halogenated organophosphates, organophosphonates, and organophosphinates. Suitable non-phosphorous containing flame retardants include halogen-containing compounds (e.g. chloroparaffins, polyvinyl chloride, hexabromocyclododecane (HBCD), brominated aromatic compounds), nitrogen-containing compounds (e.g. melamine, melamine cyanurate, melamine phosphates/pyrophosphates/polyphosphates, melamine borate, and other melamine derivatives), and inorganic compounds (e.g. aluminum trihydroxide and magnesium dihydroxide). Flame retardants can be used in combination with a synergist to enhance their efficiency (e.g. antimony trioxide, antimony pentoxide, and sodium antimonite).

Exemplary flame retardants that may be used in the present invention include, but are not limited to diammonium phosphate (DAP), triethylphosphate, tricresyl phosphate (TCP), tris(isopropylphenyl)phosphate (TIPP), tris(2-chloroethyl)phosphate (TCEP), tris(1-chloro-2-propyl)phosphate (TCPP), tris(1,3-dichloro-2-propyl)phosphate (TDCPP), tris(2,3-dibromopropyl)phosphate (TDBPP), dimethyl methylphosphonate (DMMP), diethyl ethylphosphonate (DEEP), chloroparaffins, polyvinyl chloride, melamine, aluminum hydroxide or a mixture thereof.

Particularly preferred flame retardants include, but are not limited to, Fyrol PCF from ICL Industrial Products (Beer Sheva, Israel), Paroil 56 NR from Dover Chemical (Dover, Ohio) and PHT-4 Diol from Chemtura Corporation (Philadelphia, Pa.). Preferably, the flame retardant is present in the one-component foam forming composition of the present invention in an amount from 5 to 15 wt. %. For two component foam forming compositions, the flame retardant is preferably 5 to 45 wt. % of the B-side.

In addition to the previously described ingredients, other auxiliaries such as cross-linking agents, stabilizers, pigments, chain-extending agents, plasticizers, and fillers can be employed within a range that would not hinder the object of the present invention. The auxiliary agents and additives are generally mixed with the polyol in the preparation of both one and two component foam forming compositions.

### Methods of Preparing One-Component Foam Forming Compositions

The one-component foam forming compositions of the present invention are made by combining the polyol, flame retardant, surfactant, catalyst, and optional additives into a premix, then adding a liquefied form of the rodent repellent to the premix to give a polyol blend. A suitable vessel is then charged with the polyol blend, the polyisocyanate, and an acceptable blowing agent.

Preferably, the one-component foam forming composition is under pressure, such as, for example, in a valved aerosol can. The aerosol can has a dispenser attached to the can for dispensing the composition into a foamed state. The dispenser may be further adapted with an extender, preferably a straw-like attachment temporarily or permanently affixed to the end of the dispenser. One component-foam forming compositions in aerosol cans are particularly well suited for small projects, such as sealing gaps and crevices.

The one-component foam forming composition may also be dispensed from a pressurized cylinder equipped with hose and wand assembly.

### Methods of Preparing Two-Component Foam Forming Compositions

In two-component foam forming compositions, the A-side and B-side are prepared and packaged separately. To prepare the A-side, a dispensing vessel is charged with the polyisocyanate, the blowing agent, and other additives. To prepare the B-side, a premix is prepared by combining polyol, flame retardant, catalyst, surfactant, and optional additives at room temperature. To this premix is added a liquefied rodent repellent to give a polyol blend. A second dispensing vessel is charged with the polyol blend and a blowing agent. The two dispensing vessels are connected using hoses and a gun with a suitable construction that allows the two components to mix before being applied to the desired surface.

### Methods of Use

The polyurethane foams of the present invention combine the insulating benefits of conventional polyurethane foams with the additional benefit of providing a rodent repellent material. The one-component polyurethane foams can be applied as a continuous bead. This single line application of foam insulation provides an effective seal against air leakage in holes, gaps, and cracks, as may typically be found near door and window frames, baseboards, electrical outlet, cable television and phone lines, heat and air vents, dryer vents, faucets, pipe/wire/conduit penetrations, electric/gas/air conditioner penetrations, plumbing, attic hatches, and along garage ceiling and wall joints. This is advantageous in applications where traditional high-pressure two-component “foamed in place” sprays are not suitable. Specialized equipment such as Gusmer® spray foam equipment dispenses two-component foams under high pressure, and cannot be used with the same degree of control.

The two component spray foams provide a rodent repellent material suitable for various applications including, but not limited to spray roofing, air sealing, insulation, and cavity filling. Preferably, the one- and two-component foams of this invention are used for interior, or covered, applications.

### DEFINITIONS

As used herein, the term “rodents” refers to members of the rodentia order, for example, mice, rats, squirrels, guinea pigs, hamsters, gerbils, chipmunks, voles, pocket gophers and other rodents.

As used herein, a compound is a “rodent repellent” if it substantially decreases rodent consumption or utilization of a polyurethane foam as compared to rodent consumption or utilization of the same polyurethane foam in the absence of such repellent compound.

Having described the invention in detail, it will be apparent that modifications and variations are possible without departing from the scope of the invention defined in the appended claims.

### EXAMPLES

The following non-limiting examples are provided to further illustrate the present invention.

### Example 1

### One-Component “Straw” Foam

A mixing vessel is charged sequentially with 61 wt. % polyether polyol, 20 wt. % flame retardant, 2 wt. % silicone surfactant, and 2 wt. % tertiary amine catalyst). To this premix is then added 15 wt. % of rodent repellent, previously liquified at 49-54° C., to give a polyol blend.

The polyol blend is provided in an amount of 36 wt. % to an aerosol can, followed by 47 wt. % polyisocyanate. An aerosol type valve is crimped onto the can. The can is then charged with 8 wt. % dimethyl ether (blowing agent) and 9 wt. % of a mixture of propane and isobutane (blowing agent).

The application temperature for the foam is in the range of about 10° C. to about 49° C., and preferably in the range of about 16° C. to about 32° C. The surface cure time for a foam applied at 25° C. is about 25 to 35 minutes.

Analysis of the resultant foam reveals a high quality foam, having a very good cell structure and standard foam surface appearance. The foam density is measured to be about 12 kg/m³ and has a closed cell content of <10%. The R-value of the foam is calculated to be 3.7.

TABLE 1
Formulation for One-Component “Straw” Foam Forming Composition

| Ingredient | Wt. % |
|---|---|
| polyisocyanate | 47.0 |
| polyether polyol | 22.0 |
| flame retardant | 7.2 |
| silicone surfactant | 0.70 |
| tertiary amine | 0.70 |
| catalyst | |
| rodent repellent | 5.4 |
| blowing agent | 8.0 |
| blowing agent | 9.0 |

### Example 2

### One-Component “Cylinder” Foam

A mixing vessel is charged sequentially with 50 wt. % polyether polyol, 27 wt. % flame retardant, 3 wt. % silicone surfactant, and 2 wt. % tertiary amine catalyst). To this premix is then added 18 wt. % of rodent repellent, previously liquefied at 49-54° C., to give a polyol blend.

The polyol blend is provided in an amount of 27 wt. % to a cylindrical canister, followed by 45.0 wt. % polyisocyanate. The canister is then charged with 28.0 wt. % blowing agent. The canister is then agitated for a minimum of 3 minutes.

The application temperature for the foam is in the range of about 10° C. to about 49° C. and preferably in the range of about 16° C. to about 38° C. The surface cure time for a foam applied at 75° C. is about 8 to 15 minutes.

Analysis of the resultant foam reveals a high quality foam, having a very good cell structure and standard foam surface appearance. The foam density is measured to be 28 kg/m³ and has a closed cell content of about 70%. The R-value of the foam was calculated to be 5.

TABLE 2
Formulation for One-Component
“Cylinder” Foam Forming Composition

| Ingredient | Wt. % |
|---|---|
| polyisocyanate | 45.0 |
| polyether polyol | 13.5 |
| flame retardant | 7.3 |
| silicone surfactant | 0.80 |
| amine catalyst | 0.50 |
| rodent repellent | 4.9 |
| blowing agent | 28.0 |

### Example 3

### Two-Component Foam

A mixing vessel is charged with 20 wt. % polyol, 30 wt. % polyol, 10 wt. % polyol, 15 wt. % flame retardant, 3 wt. % silicone surfactant, 0.2 wt. % organotin catalyst, 1.5 wt. % water, and 6.3% blowing agent. To this premix is then added 14 wt. % rodent repellent, previously liquefied at 49-54° C., to give a polyol blend.

The polyol blend is provided in an amount of 75 wt. % to a cylindrical canister. The canister is then charged with 25 wt. % blowing agent. This canister contains the B-side.

The isocyanate is provided in an amount of 88 wt. % to a cylindrical canister, which is then charged with 12 wt. % blowing agent. This canister contains the A-side.

The application temperature for the foam is in the range of about 16° C. to about 38° C. and preferably in the range of about 21° C. to about 32° C.

The two components are dispensed through plastic hoses to a gun with a mixing nozzle. The mixing nozzle allows the polyol blend and the isocyanate components to mix before expelling from the gun onto the targeted surface. The surface tack free for a foam applied at 75° C. is about 30 to 60 seconds.

Analysis of the resultant foam reveals a high quality foam, having a very good cell structure and standard foam surface appearance. The foam density is measured to be 30 kg/m³ and has a closed cell content of >90%. The R-value of the foam is calculated to be 6.2.

TABLE 3
Formulation for Two-Component Foam Forming Composition

| Component | Ingredient | Wt. % |
|---|---|---|
| “A”-Side | polyisocyanate | 88 |
| | Blowing agent | 12 |
| “B”-Side | *Polyol Blend | 75.0 |
| | blowing agent | 25.0 |
| *Polyol | polyol | 20 |
| Blend | polyol | 30 |
| | polyol | 10 |
| | flame retardant | 15 |
| | silicone surfactant | 3 |
| | organotin catalyst | 0.2 |
| | water | 1.5 |
| | blowing agent | 6.3 |
| | rodent repellent | 14 |

### Example 4

### Physical Properties of the Foams

The foams produced are assessed for the following physical properties:

Foam density is determined as described in ASTM D1622 by measuring the core density.

Resistance to heat flow (R-value) is calculated as the reciprocal of the thermal conductivity factor (K-factor). The determination of K-factor is carried out as described in ASTM C518.

The % closed cells is determined as described in ASTM D6226.

The properties of the foams produced according to Examples 1-3 are summarized in Table 4.

TABLE 4
Physical Properties of Rodent Repellent Foams

| Example # | Density (kg/m³) | % Closed Cell | R-value |
|---|---|---|---|
| 1 | 12 | <10 | 3.7 |
| 2 | 28 | 70 | 5 |
| 3 | 30 | >90 | 6.2 |

### Example 5

### Accelerated Shelf-Life Stability Test

To determine the shelf life stability of one-component foam forming compositions, an accelerated shelf-life stability test is conducted. Multiple aerosol cans comprising the one-component “straw” foam forming composition are prepared according to Example 1. The test cans each comprise 5 wt. % rodent repellent. The test cans are placed in an oven at 120° F. along with an aerosol can of a control foam lacking the rodent repellent.

At 4 week intervals, simulating 3 months of shelf-life at 25° F., the cans are removed and foam sprayed. Cell structure of the test foams and control foam is done by visual inspection.

The cell rating of each of the foams samples is evaluated at 4, 8, 12, and 16 weeks, and their cell rating is compared to an initial cell rating at T=0 weeks.

The test foams are observed to maintain their cell structure, which indicates a stable foam. Stability testing shows equal or better cell structure for test foams containing rodent repellent as compared to the control.

TABLE 5

| | | |
|---|---|---|
| | Spray | |
| Can | Ropey | Cell Rating |

Control sprays, 0-weeks oven

| | | |
|---|---|---|
| TNS QC Lab Made Shelf | Not at all | |
| Life @ 68° F. | | |
| p-DCB 3% | Not at all | Normal |
| p-DCB 5% | Not at all | Normal |
| o-DCB 3% | Not at all | Normal |
| o-DCB 5% | Not at all | Normal |

2-weeks oven (No 3% testing)

| | | |
|---|---|---|
| p-DCB 5% | Not at all | Normal |
| o-DCB 5% | Not at all | Normal |

4-weeks oven

| | | |
|---|---|---|
| p-DCB 3% | Not at all | Normal |
| p-DCB 5% | Not at all | Normal |
| o-DCB 3% | Not at all | Normal |
| o-DCB 5% | Not at all | Normal |

8-weeks oven

| | | |
|---|---|---|
| p-DCB 3% | Slightly | Slightly larger than normal |
| | Ropey | |
| p-DCB 5% | Not at all | Normal |
| o-DCB 3% | Slightly | Normal |
| | Ropey | |
| o-DCB 5% | Not at all | Normal |

12-weeks oven

| | | |
|---|---|---|
| p-DCB 3% | Slightly | 2x normal size, consistent cell |
| | | size though. |
| p-DCB 5% | Not at all | Normal |
| o-DCB 3% | Slightly | 2x normal size, consistent cell |
| | | size though. |
| o-DCB 5% | Not at all | Normal |

16-weeks oven

| | | |
|---|---|---|
| p-DCB 3% | Ropey | 2x normal size, consistent cell |
| | | size though. |
| p-DCB 5% | Ropey | 2x normal size, consistent cell |
| | | size though. |
| o-DCB 3% | Ropey | 2x normal size, consistent cell |
| | | size though. |
| o-DCB 5% | Ropey | 2x normal size, consistent cell |
| | | size though. |

### Example 6

### Evaporation Test

To determine the amount of rodent repellent in the polyurethane foam of the invention as a function of time, an evaporation test is conducted (FIG. 1). A one-component straw polyurethane foam comprising 6.0 wt. % para-dichlorobenzene (PDCB) is prepared according to Example 1. A sample of the foam is applied as a bead to a non-stick surface, and then is allowed to age for a period of 10 months in a room with controlled temperature (25° C.) and relative humidity (50%). An independent testing lab analyzes the PDCB content of the foam by GC/MS.

As can be seen from FIG. 1, the amount of PDCB within the polyurethane foam diminishes over about 9 months to about 2 wt. %. These test results show that there is sufficient PDCB in the aged polyurethane foam to repel rodents.

### Example 7

### Efficacy Test with Mice

To determine the efficacy of the rodent repellent foams of the invention, the following three experiments are conducted. For these experiments, each of two 10-gallon aquarium tanks are divided in half by a wooden divider wall containing holes about 1.5 to 2 inches in diameter. For the control tank, Spray ‘n Foam® from Convenience Products (Fenton, Mo.) is used to fill the holes in the divider. For the test tank, a foam comprising 5 wt. % para-dichlorobenzene is used to fill the holes in the divider. Male mice are place on one side of the divider and a female mouse and/or food are used as lure on the other side of the divider. Both male and female mice are provided water. The tank is covered with a lid.

In test 1, three male mice are placed in both the control tank and test tanks. The lure used is a female mouse. Mice in the control tank are observed to eat through the foam in less than one hour and reach the other side of the tank. Mice in the test tank do not eat the foam and die within several days.

In test 2, the same conditions are repeated as in test 1, with similar results. Mice in the control tank are observed to eat through the foam quickly and reach the other side of the tank. Mice in the test tank chew on the foam after 3 days, and die within 24 hours. None of the mice reach the other side of the tank.

In test 3, the same conditions are repeated as in tests 1 and 2 but additionally, a female mouse and peanut butter are placed as lure on the other side of the tank. Mice in the control tank are observed to eat through the foam quickly and reach the lure on the other side. In the test tank, one of the three mice begins to chew on the foam after 2 days. This mouse alternately spits and chews foam, and reaches the other side. It dies within 24 hours of starting to chew on the foam.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description shall be interpreted as illustrative and not in a limiting sense.

1. A one-component polyurethane foam forming composition comprising:
(a) about 35 to about 55% by weight of a polyisocyanate;
(b) about 10 to about 30% by weight of a polyol;
(c) about 1 to about 10% by weight of a rodent repellent; and
(d) about 10 to about 30% by weight of a blowing agent;
wherein the weight ratio of polyisocyanate and polyol are such that the NCO/OH equivalent ratio is within the range of about 3:1 to about 10:1; and the composition has a shelf-life stability of at least 12 months at 25° C.

2. The composition of claim 1 wherein the composition comprises from about 3 to about 10% by weight of the rodent repellent.

3.-66. (canceled)

67. The composition of claim 1 further comprising about 0.1 to about 3% by weight of a silicone surfactant.

68. The composition of claim 1 further comprising about 0.1 to about 3% by weight of a catalyst.

69. The composition of claim 1 further comprising about 0.1 to about 3% by weight of a silicone surfactant and about 0.1 to about 3% by weight of a catalyst.

70. The composition of claim 1 further comprising about 5 to about 15% by weight of a flame retardant and/or a plasticizer.

71. The composition of claim 1 wherein the polyisocyanate comprises an aromatic polyisocyanate, the aromatic polyisocyanate comprising monomeric methylene diphenyl diisocyanate (MDI), polymeric methylene diphenyl diisocyanate (PMDI), or a mixture thereof.

72. The composition of claim 1 wherein the polyol comprises a polyether polyol, a polyester polyol, a polybutadiene polyol, a polycaprolactone polyol, a polycarbonate polyol, a hydroxyl-terminated polyolefin polyol, a graphed polyol, a polyol derived from a natural source, or a mixture thereof.

73. The composition of claim 1 wherein the rodent repellent comprises a chemical that is an eye and mucous membrane irritant.

74. The composition of claim 73 wherein the eye and mucous membrane irritant comprises 1,2-dichlorobenzene, 1,3-dichlorobenzene, 1,4-dichlorobenzene or a mixture thereof.

75. A two-component polyurethane foam forming composition which comprises:
an “A”-side comprising:
about 70 to about 95% by weight of a polyisocyanate;
about 4 to about 15% by weight of a blowing agent; and
about 1 to about 10% by weight of dichlorobenzene; and
a “B”-side comprising:
about 20 to about 70% by weight of a polyol; and
about 2 to about 30% by weight of a blowing agent;
wherein the weight ratio of polyisocyanate and polyol are such that the NCO/OH equivalent ratio ranges from about 0.8:1 to about 1.4:1.

76. A two-component polyurethane foam forming composition which comprises:
an “A”-side comprising:
about 80 to about 95% by weight of a polyisocyanate; and
about 5 to about 15% by weight of a blowing agent; and
a “B”-side comprising:
about 20 to about 70% by weight of a polyol;
about 2 to about 30% by weight of a blowing agent; and
about 1 to about 11% by weight of dichlorobenzene;
wherein the weight ratio of polyisocyanate and polyol are such that the NCO/OH equivalent ratio ranges from about 0.8:1 to about 1.4:1.

77. A two-component polyurethane foam forming composition which comprises:
an “A”-side comprising:
about 75 to about 95% by weight of a polyisocyanate;
about 4 to about 15% by weight of a blowing agent; and
about 1 to about 10% by weight of dichlorobenzene; and
a “B”-side comprising:
about 20 to about 70% by weight of a polyol;
about 2 to about 30% by weight of a blowing agent; and
about 1 to about 11% by weight of dichlorobenzene;
wherein the weight ratio of polyisocyanate and polyol are such that the NCO/OH equivalent ratio ranges from about 0.8:1 to about 1.4:1.
